(19) United States
(12) Patent Application Publication
(10) Pub. No.: US 2018/0342014 A1
(43) Pub. Date: Nov. 29, 2018

(54) FRAMEWORK FOR DECOUPLED DEVELOPMENT AND MANAGEMENT OF SCALABLY-MERGEABLE TRADING STRATEGIES

(71) Applicant: DataSciU Corporation, Redmond, WA (US)

(72) Inventor: Ervin Peretz, Redmond, WA (US)

(21) Appl. No.: 15/607,209

(22) Filed: May 26, 2017

(51) Int. Cl. G06Q 40/06; G06Q 40/04; G06F 17/15

(52) U.S. Cl. CPC G06Q 40/06; G06F 17/15; G06Q 40/04

(57) ABSTRACT

A facility for scalably decoupled development and merging of equity trading strategies and trading execution plans is disclosed. The facility provides a service by which a user may discover correlations between a sequence of event times and upticks of traded equities, such as stocks. The facility can also confirm a suspected correlation between event times and equity upticks. If the event sequence continues into the future at predictable times, and the correlation between the events and equity upticks continues into the future, then the correlation may be profitably acted upon by buying and selling the equity around the times of the projected equity upticks. The facility provides a utility by which many such correlations may be discovered, confirmed, ranked, and merged into a complex trading sequence across many equities, that were identified from many such discovered correlations.

### BACKGROUND

Many strategies and models have been implemented for predicting price movement of traded equities such as company stocks. High-frequency trading (HFT) accounts for a large fraction of trading volume on the major stock exchanges, and is based on predicting small moves in stock prices, based on, for example, near-term momentum, demand, and correlations between pairs of stocks. Hedge funds implement more advanced trading algorithms, which are highly proprietary. In addition to analyzing the market itself, these algorithms may correlate against external factors, such as industry news, earnings announcements, political events, and daily news. Central to an automated trading strategy is a learning model, which takes input in the form of market or other events, and outputs a set of trading actions (or a scoring of favorable equities, which directly implies a set of trading actions).

A single model exploits a single class of input information, applying a single learning algorithm towards a set of market or trading actions (such as buying/selling stocks, bonds, ETF, etc.). A single trading model may generate no suggested trading actions for a given day, or over an extended period. For example, the model may make predictions around the times of quarterly earnings announcements of tech companies. An investment firm that depended only on this model would have its funds lying dormant at other times.

Even for times when a model does generate trading actions, the trading actions for a given day may be exploitable for only a limited volume of funds. For example, the output trading action may suggest buying 10,000 shares of IBM stock at 10 am, and selling them all at 11 am, at an expected profit. The number of shares in such a suggested trading action (or set of trading actions) may be so limited, because purchasing a larger volume of shares could affect the market price, forcing a higher purchase price on subsequent shares, and therefore eliminating the expected profit opportunity. Furthermore, if a higher number of shares were to be bought, then subsequent shares may not be sellable at the expected price—again eliminating the expected profit opportunity. A single trading model, then, offers limited profit value, due to its limited scope of input data and algorithm, as well as limited funds to which its generated actions can be applied.

### Merging Outputs of Multiple Models

Any hedge fund, financially-oriented team of data scientists, or similar team or effort thus tends to build or exploit multiple models. There then arises the challenge of how to merge the suggested trading actions from multiple models into a single execution plan for investing a finite set of funds. Merging the trading actions suggested by multiple models is simple in some cases. For example, if model A suggests buying $500 of IBM stock on a given day (or a certain time on a given day), and model B suggests buying $500 of Intel stock on the same day or time, then as long as there are at least $1000 of investable funds, the merged execution plan will be to purchase the recommended quantities of both equities. In other cases, however, the merging of multiple trading models can be more involved. For example, if model A suggests buying up to $2 million of IBM stock on a given day, and model B suggests buying up to $3 million of Intel stock on a given day, and there are only $1 million of investable funds, there are a variety of reasonable merged trading plans. The merged plan, upon execution, may purchase (or cause to be purchased) equal amounts of each stock, it may invest all funds in accordance with one of the models, or it may divide the available funds pro rata according to each model's respective estimated opportunities (in this example, ⅖ of $1 million in IBM, and ⅗ of $1 million in Intel). In some cases, investment managers may have higher confidence in one model over another. So, for example, the investment managers may typically invest all possible funds in accordance with the suggestions of model A, and only remaining funds in accordance to suggestions of model B, if they have a higher confidence in model A.

Furthermore, the models themselves may express a score or statistical confidence level in a trading suggestion. If the component models each express a statistical confidence level (and the expressed confidence levels are trusted by the investment managers), then the merged plan may be to favor the trading actions that were assigned a higher confidence level by the generating model. Confusion may arise, however, when the models are considered to have varying quality. For example, if model A is considered better than model B, and model A suggests a trading action for a given day with a confidence of 60%, and model B suggests a trading action for the same day with a confidence of 65%, it may then be unclear whether to prefer the trading actions that were assigned a higher confidence by an inferior model.

When one or more models cannot assign a statistical confidence score to trading actions, this raises a further set of complications. If the models all generate a score with each suggested trading action, expressing each model's confidence in the quality of the suggestion, then the standard data science technique is to “normalize” the scores for comparison. For example, if model A issues each trading action a score in the range of 0 to 10, and model B issues each trading action a score in the range of 0 to 100, then for comparison, the investment managers (or merging system) may divide model A's scores by 10, and model B's scores by 100; the resulting scores would be in the range of 0 to 1, for numeric comparison. There are however further complications, in that the relative distributions of scores issued by each model may vary. For example, model A may assign scores to its suggested trading actions fairly uniformly in the range 0 to 10, while model B may assign most trading actions a score in the range of 0 to 50, with scores between 50 and 100 being extremely rare. In such a case, a trading action by model A with a score of 10 would not be commensurate to a trading action by model B with a score of 100; the normalized scores would both be 1, but it would be an error to treat them as commensurate.

In addition to all the aforementioned complications, there is additional complexity introduced when the models predict varying profits from their respective suggested trading actions. For example, model A may suggest a trading action for a given day with 60% confidence of generating a 1% profit, for up to $1000 invested; while model B may suggest a trading action for the same day with 75% confidence of generating a 0.8% profit, for up to $750 invested. Even with only 2 models, it becomes increasingly complex to generate an optimum or improved merged trading plan from the input models, especially when the models themselves are perceived as having varying quality.

Increasing this already high level of complexity exponentially more is the fact that confidence levels for variable quantities are often not expressed as a single value, but as probability distributions. So a real-world model's profit expectation for a trading action would often not be as simple as “60% confidence of generating 1% profit,” but a continuum of confidence levels versus ranges of profit, entailing, for example: 80% confidence of being net positive; 70% confidence of generating at least 0.5% profit; 60% confidence of generating at least 1% profit; etc.

### Scaling Collaboration of Financial Data Science

Modern financial institutions—such as mutual funds and hedge funds—that are involved in developing and executing competitive equity trading strategies, employ computer programmers and data scientists to develop “machine learning” or similar data science models.

Each such financial institution develops proprietary mechanisms for coordinating suggested trading actions from multiple models. These coordination techniques are often built into the development process. For example, each computer-generated model developed in-house may be coordinated to output its results using a common template, to facilitate processing by a merging system. Furthermore, each model's scorings may be pre-normalized so as to make them comparable by the merging system.

Collaborated development of multiple models is highly advantageous, in that it allows for sharing of databases and software tools, as well as collaborated ideation and development. As a financial institution's investable funds grow, there is an urgent necessity to scale to ever-larger numbers of coordinated trading models, because each model offers a limited exploitable financial opportunity. There is therefore pressure to scale the development of trading models to ever-larger groups of data scientist sub-teams, exceeding the number that can be accommodated in a single office, or even hired in a single region.

As a practical matter, it is very difficult to coordinate the development of trading models by loosely-coupled teams, such that the resulting trading actions can be intelligently merged. This is especially true if there is incomplete trust between the teams. For example, if a merging criterion is a confidence score or other quality score output by the various teams' models, then there is a need for common standards defining these scorings; and there is incentive to overstate the quality or confidence associated with one's own model.

### Simulation and Evaluation of Trading Models

A favorable hallmark of investment modeling is that any model can be tested in simulation before risking real money on its trading suggestions. First, a candidate trading model can be backtested against past market price data, to determine its profitability retroactively. Then, to demonstrate the model's predictive power and profit potential to investment firm managers or investors, the model can be “forward tested” by simulating the model's suggested buy and sell actions against real-time market price data, and gauging the simulated profit.

An investment firm that is coordinating the development of multiple trading models will almost certainly as a policy evaluate each new model in simulation mode, wherein its suggested buy and sell actions are not actually executed with real investment funds, but simply tabulated along with the price of the intended equities at the intended times. The trading model under simulation is then evaluated according to the profit that would have been attained had the model's suggested trading actions been made with actual investment funds. Such a simple simulation is highly accurate for quantities of equities that are not a substantial portion of the trading volume of the equities, such that real buying and selling of the equities in those quantities would not substantially affect their market price.

Furthermore, since there is no practical limit to the number of concurrent simulations that can be executed, a merged trading model—comprised of the trading actions from multiple models, and possibly produced by multiple data science teams—can be evaluated under simulation, and produce a quality assessment of the profitability of the merged model, as well as each component model.

Furthermore, simulation can be concurrent with real-money execution of a trading model. Therefore, in a business scheme where researchers independently develop trading models, and are rewarded based on each model's contribution to the profit attained by a merged trading model, the pro-rata distribution of financial rewards to the researchers producing the component models is well-defined, because each component model can be straightforwardly evaluated for its profitability over a given past time period of trading.

However the actual merging problem must be overcome. Even if the central managers evaluate a component model as “good,” they cannot independently assess in advance the quality or confidence of the individual trade suggestions. Therefore, the panacea of infinitely scalable distributed development of trading models, evaluated individually through simulation, and then merged into a single real-money trading pattern, is blocked by the difficulty of merging disparate trading models produced by loosely-coupled teams of data scientists.

If such a distributed scheme were possible, the decoupling could be extreme. For example the data scientists contributing trading models might not be employed by the central investment firm. They could be independent contractors, or even individual data scientists or students contributing models that they developed part-time. The independent simulation and evaluation of many trading models can be scaled to an infinite degree; as can the co-execution of a merged trading model with many positively evaluated component trading models. The crux of the problem is the rational merging of the trading models into a single trading plan. This is what has prevented a successful service that opens collaborative quant (quantitative) trading to the masses.

### Previous Efforts at Open Quant Trading

Several companies and facilities have publicly offered quantitative (quant) trading functionality to individuals and small firms. Most such facilities are simply a packaging of software libraries, databases, and access to current market data, for the purpose of developing custom trading plans that do not merge with those of other researchers. For example, SmartQuant offers a product called OpenQuant, which is an IDE (integrated development environment) for developing and testing individual market trading strategies. A major limitation of these facilities is that, unlike the proposed facility, they do not allow for the rational aggregation of separately developed strategies into a combined strategy.

### The Golden Path

A motivating factor for the disclosed techniques is the inventor's concept of the “golden path”. On any open market day, there exists some ultimately prescient trading strategy with maximally stupendous returns—which can, for example, turn a $100 investment into $1 billion. On a typical trading day, there is some stock that moves up a few percentage points in price every few seconds. At that compounding rate, $100 can grow to $1 billion in a single trading day.

This mythically optimal “golden path” strategy would begin by investing the initial $100 in the stock whose price would increase the most in the first few seconds. It would then sell the first stock and buy the stock that would increase the most in the following few seconds; etc. At some point, the growing investment pool would be too great to profitably invest in a single stock; so the hypothetical algorithm would switch to multiple high-performing stocks concurrently.

The “golden path” is simply an illustrative concept of how immensely profitable a fast-moving trading strategy can be, in the limit. No actual trading strategy comes close to this optimum, of course. The “golden path” concept simply illustrates how sub-optimal ALL trading strategies are; and how the opportunity to refine and improve a trading strategy is virtually limitless.

It also illustrates the value of time-precision in market prescience. An uptick prediction in a very narrow time range is more valuable than one for a less-specific time range, because the former frees up the funds quicker for other investment opportunities.

By creating a facility for managing and merging trading plans from nearly limitless trading strategies, built from the market insights of a nearly limitless number of researchers, the facility facilitates the practical pursuit of a merged trading strategy which, in the limit, approaches the aforementioned “golden path”.

### BRIEF DESCRIPTION OF THE DRAWINGS

FIG. 1 is a page diagram illustrating the input of a sequence for correlation with equity upticks.

FIG. 2 is a page diagram illustrating the input of a sequence for correlation with equity upticks.

FIG. 3 is a page diagram illustrating the output of a set of equities whose upticks were found to be correlated with a sequence.

FIG. 4 is a page diagram illustrating ticker charts for correlated equities.

FIG. 5 is a page diagram illustrating specific buy and sell trade actions.

FIG. 6 is page diagram illustrating the selection of multiple sequences.

FIG. 7 is a page diagram illustrating a prompt by the facility for a user to enter an investable cash amount.

FIG. 8 is a page diagram illustrating trading plans for multiple equities and a merged trading plan.

FIG. 9 is a page diagram illustrating the selection of sequences.

FIG. 10 is a page diagram illustrating a merged trading plan.

FIG. 11 is a page diagram illustrating specific buy and sell trade actions.

FIG. 12 is a flow diagram illustrating the processing of a build trading plan component.

FIG. 13 is a flow diagram illustrating the processing of an identify positively correlated equities component.

FIG. 14 is a flow diagram illustrating the processing of a determine correlation value component.

FIG. 15 is a block diagram showing some of the components typically incorporated in at least some of the computer systems and other devices on which the facility executes.

### DETAILED DESCRIPTION

A facility providing systems and methods for decoupled development and management of scalably mergeable trading strategies for equity markets is disclosed. Herein, “scalably mergeable” indicates that separately developed trading strategies may be merged repeatedly, into a single merged trading plan that guides the application of a single quantity of investment funds between highly frequent statistical profit opportunities, with potential for higher profit than traditional strategies. A non-scalably mergeable trading strategy, on the other hand, is a trading strategy that cannot be merged with other strategies into a merged trading strategy. A trading strategy may not be scalably mergeable if it does not specify specific trading times or dates, requires long hold times for equities, or specifies hold times that frequently overlap with other trading strategies of a similar type.

### Trading Group

A basic concept and component of functionality of the facility is a Trading Group. A Trading Group is simply a group of equities, such as company stocks, bonds, ETFs, etc., which are grouped and saved together for contemplated trading within a single plan and timeline.

### Trading Plan

Another basic concept and component of functionality of the facility is a Trading Plan. A Trading Plan is a Trading Group, with an associated set of buy and sell actions for each equity, each action with a specified date and/or time.

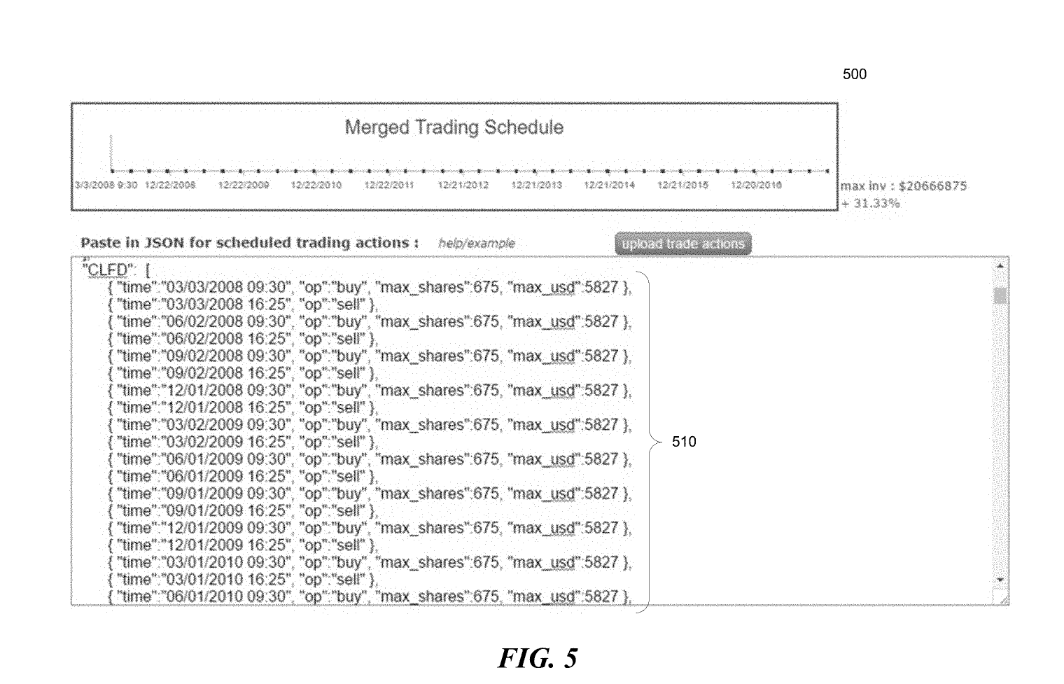

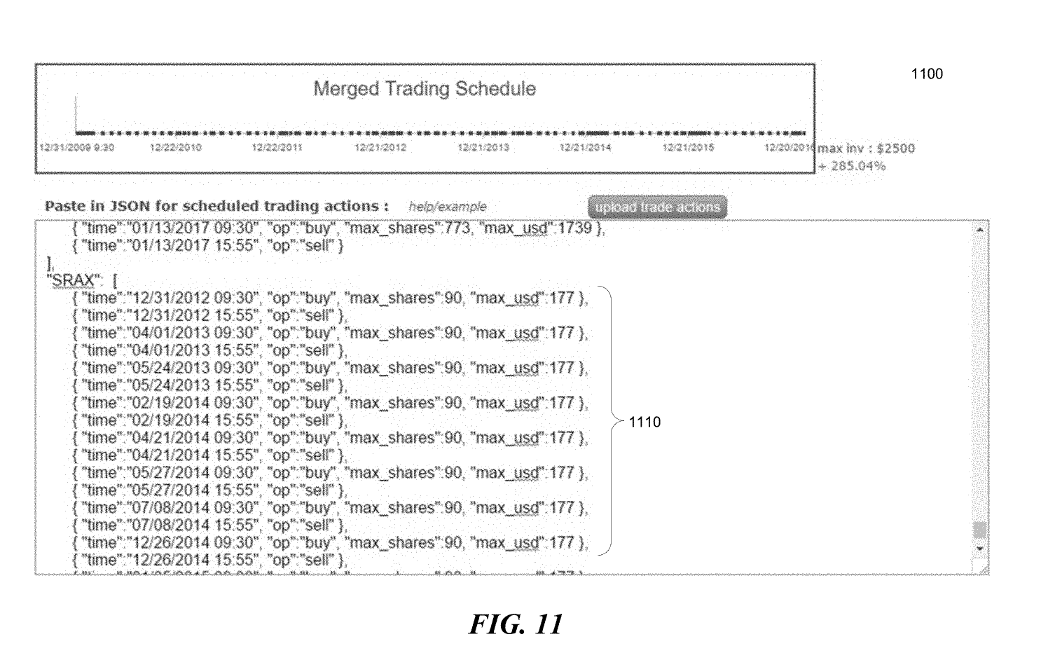

In some embodiments, each buy action associated with a trading plan has an associated maximum number of shares (max_shares) and/or a maximum investable dollar amount (max_usd), which was determined (by the facility or other creation mechanism) as the estimated maximum exploitable projected investment opportunity. For example, the facility may determine a maximum number of shares for a buy action associated with a particular equity based on the average daily volume of that equity. A trading plan, or portions thereof, can be saved and expressed by the facility in the form of computable script, such as a JSON (JavaScript Object Notation) script as shown in FIGS. 5 and 11, such that the trading plan (or portions thereof) can be ingested by an automated trading system, or merged and converted into a user's merged trading plan.

### Value of a Statistical Uptick Prediction

An uptick is a short-term upward movement in the market price of an equity, such as a company stock. As used herein, an “uptick” may be the momentary change in market price between individual trades of a given equity on a given exchange; or a somewhat longer-term price movement, such as the difference between the equity's price at the open and close of trading on a given day.

The act of buying or selling an equity, by definition, affects the market for the equity. If the volume of a trade is substantial relative to the overall market volume, then it may affect the market price of the equity. However if the volume of a trade is small relative to the overall market volume, then the impact on the equity's market price may be negligible. In some cases, this “feedback” effect on an equity's market price is assumed to be negligible and estimated as zero.

At any given moment, market price may differ based on whether one is buying or selling an equity—especially for small equities with low liquidity. So for all aspects of the facility, the “market price” is taken as the top market “bid” price when selling, or the bottom market “ask” price when buying.

If an uptick prediction were known with absolute (100%) certainty, then the value of the prediction is estimated as follows:

uptick_prediction_value=predicted_uptick_ratio*max_usd

where predicted_uptick_ratio is the predicted relative market price increase (e.g. 0.1 for 10% increase) and max_usd is the maximum predicted funds that can be applied to exploit the uptick prediction. If, on the other hand, an uptick prediction is not certain, but is rather predicted with a statistical confidence level, then the value of such a statistical uptick prediction is estimated as follows:

uptick_prediction_value=confidence*predicted_uptick_ratio*max_usd

where confidence is the statistical confidence level expressed as a fraction (e.g. 0.75 for 75% confidence); and predicted_uptick_ratio and max_usd are defined as above. max_usd may be derived as the maximum ratio of the average daily monetary trading volume for the equity, which, through historical analysis, is not expected to significantly alter the market price, through deep analysis of the entire set of historic “bids” and “asks” for the equity (i.e. the entire “deep” set of unfulfilled trade requests on the market, as opposed to just the top “bid” and bottom “ask,” at any given time). max_usd may be calculated more precisely by simulating against the average daily set of “deep” bids and asks.

In the context of a system, such as the facility described herein, that facilitates the management and execution of many trading plans with trade actions at disparate times, with limited investable funds, consideration must be given to the “hold time” prescribed by the uptick prediction, where “hold time” represents the time between contiguous buy and sell actions on a single equity in a single trading plan. For example, an uptick prediction that predicts an uptick across a given hour is less valuable than an uptick prediction that predicts the same predicted_uptick_ratio with the same confidence in the timespan of just one minute. If other similar profit opportunities exist for all minutes of the given hour, then the minute-term uptick prediction is worth roughly 60 times as much as the hour-term uptick prediction, because the former can be exploited with a “hold time” of just one minute, with the funds free to exploit other similar profit opportunities during the other minutes of the hour; whereas the hour-term uptick prediction is exploitable with an hour-long “hold time.” In other words, the investable funds will be “held up” over the course of the entire hour-long period and, therefore, not usable for other actions while the funds used with the action having the shorter hold time will again be available for other actions much earlier. Moreover, the minute-term uptick prediction in the above scenario may be worth more than 60 times the hour-term uptick prediction, because of the compounding returns implied by the presence of profit opportunities each minute.

Therefore, the value of a statistical uptick prediction in the context of the disclosed facility can be estimated as follows:

uptick_prediction_value=confidence*predicted_uptick_ratio*max_usd/hold_time

where confidence, predicted_uptick_ratio, and max_usd are defined as above; and hold_time is the length of time in which the uptick prediction applies. This is the scoring formula applied by the facility in accordance with some embodiments of the disclosed technology.

### Event and Date Sequences

Another basic concept and component of functionality of the facility is the date sequence. A date sequence is a sequence of dates or times of (or shortly around) predictable public events of a similar class, whereas the events may be relevant to equity markets. Whereas other statistical quant trading tools tend to orient around features of equities, the facility is oriented around features of dates and other time periods, in relation to one or more equities. Examples of predictable public events include, but are not limited to: national holidays; ethnic or religious holidays; scheduled political events; scheduled financial or industry disclosures; sporting events; dividend pay dates; ex-dividend dates; payroll dates; tax refund dates; etc. Some events are predictable long in advance—such as ethnic holidays. Other events, such as stock dividend dates or ex-dividend dates, are known in the medium term (typically a few months in the future). Still other events, such as weather in a given locality, are only predictable in the short term.

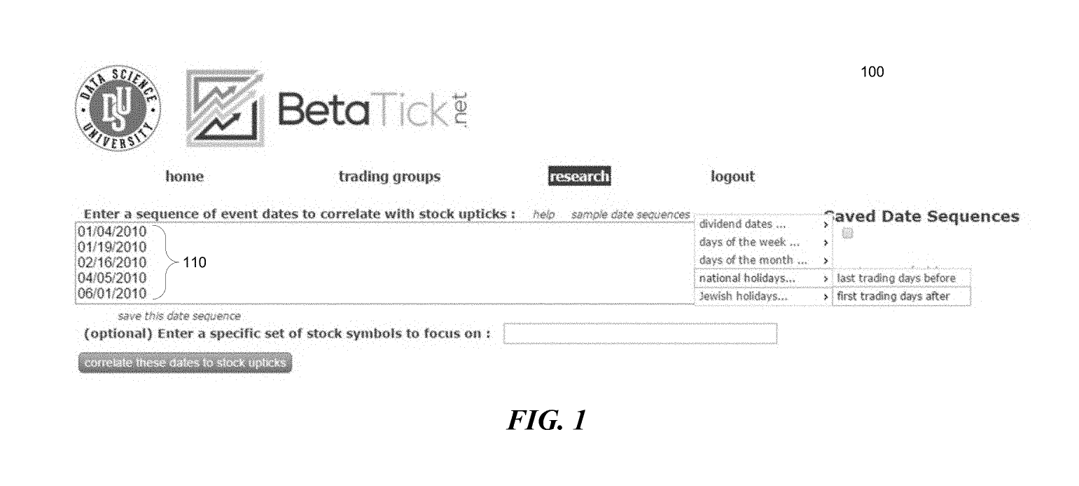

FIG. 1 is a page diagram 100 illustrating the input of a date sequence for correlation with stock upticks in accordance with some embodiments of the disclosed technology. In this example, the date sequence is a sequence of open market trading dates 110 (e.g., Jan. 4, 2010) following US national holidays.

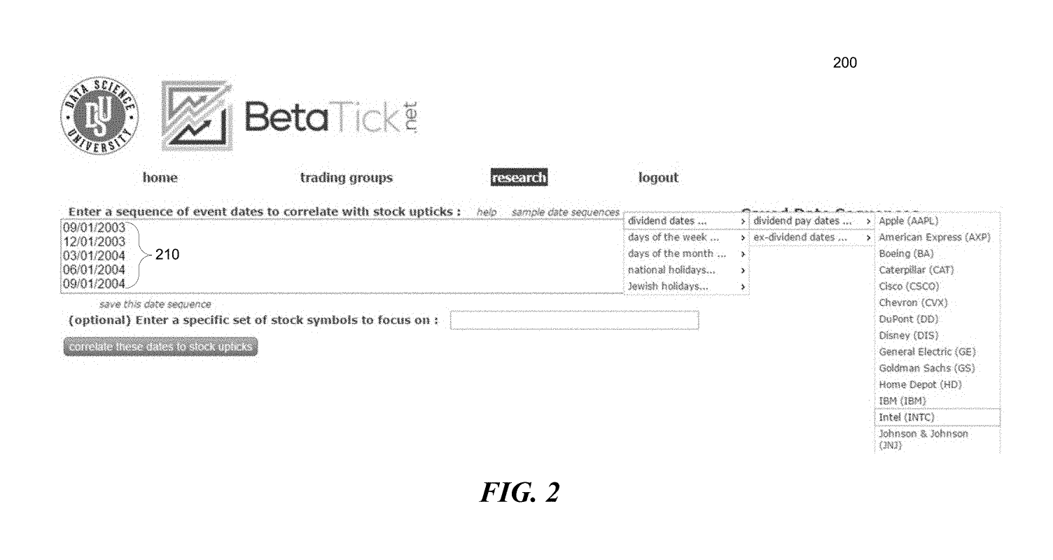

FIG. 2 is a page diagram 200 illustrating the input of a date sequence for correlation with stock upticks in accordance with some embodiments of the disclosed technology. In this example, the date sequence is a sequence of dividend pay dates; and the search is for correlations with upticks of other stocks.

In some embodiments, the facility includes functionality to compute the correlation between a date sequence and upticks of all equities for which the facility has historic price data, as described below. When a positive correlation is found between a date sequence and upticks of a given equity, then the facility scores the correlation and computes a confidence level that the correlation will continue into the future. If the date sequence includes future dates or times (due to the predictable nature of the events from which it is derived), then a trading plan that relies on that date sequence may be acted upon for future investment trading. For example, if a date sequence is specified as the first five trading days after a sporting event or national holiday, then the corresponding future date sequence(s) can be determined by determining a future date or dates of the sporting event or national holiday and then identifying the next five trading days. When a date or time in a date sequence falls on a non-trading day (or time) for a contemplated equity, the facility may replace the date or time with the closest future date or time that the equity's trading market is scheduled to be open. This captures the causal relationship between the event and uptick, whether the causal relationship is known or not.

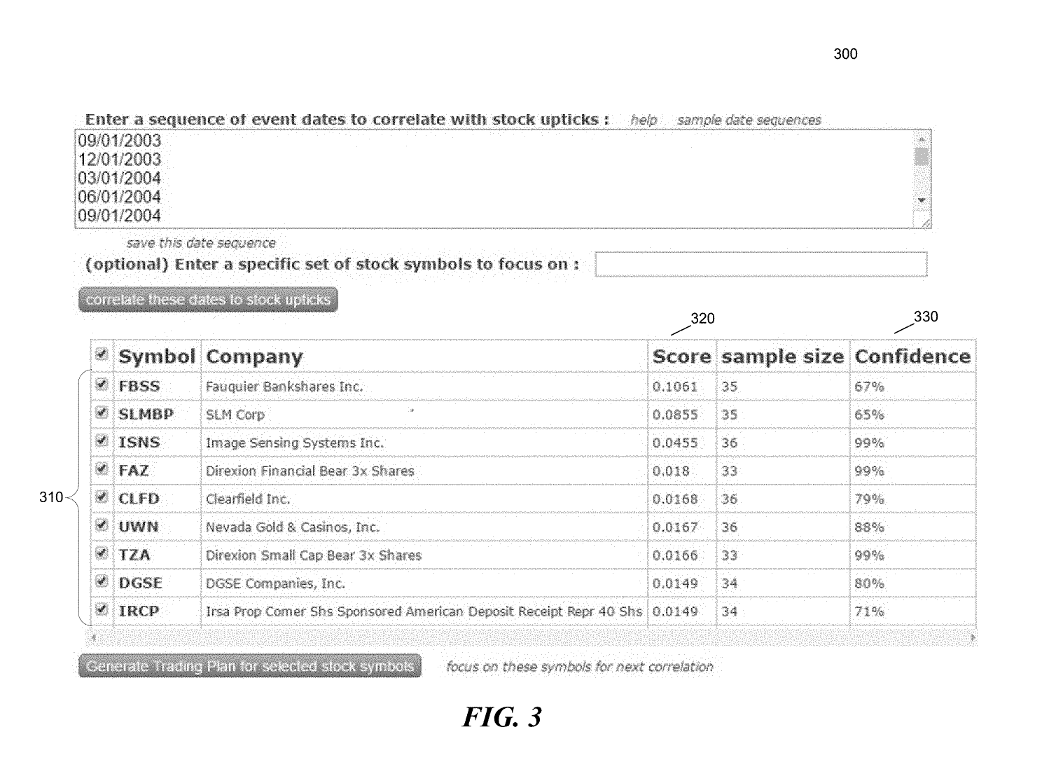

FIG. 3 is a page diagram 300 illustrating the facility's output of a set of stocks 310 in accordance with some embodiments of the disclosed technology. In this example, the stocks represented are those whose upticks were found to be correlated with a date sequence corresponding to dividend dates of Intel stock. In this example, the facility also displays a correlation score 320 and statistical confidence score 330 for each discovered correlated stock.

A positive correlation between an event sequence and equity upticks may be acted upon whether or not the causal relationship (if any) between them is known. A causal relationship may exist, but be obscured due to hidden variables. For example, a small stock's upticks may be correlated with the dividend pay date of a large dividend stock. The causal connection may be that many of the small stock's owners also own the dividend stock—so on the dividend pay date, they receive cash, which they tend to distribute across their portfolios. The fact of the high co-ownership relationship between the small and large stock is not publicly accessible; but the resulting correlation between one stock's dividend dates and the other stock's upticks can be discovered and used for future trading.

In some implementations, a date sequence is comprised of a sequence of entire day spans, such that the associated events are modeled as each consuming roughly an entire day (or length of an equity market trading day), and the associated uptick predictions have a time span of roughly one trading day (e.g., a span of 16, 20, 24 hours and so on). In other implementations, a date sequence may be substituted with timespans of longer (e.g., two days, a week) or shorter (e.g., an hour, a half hour) duration, with commensurately longer or shorter time spans of the associated uptick predictions. In particular, the date sequence in some implementations is replaced with much more brief modeled event times, possibly just a few minutes or seconds, such that the associated uptick predictions imply much briefer hold times and therefore have much larger uptick_prediction_value.

### Correlations Between Event Sequences and Equity Upticks

In some embodiments, the correlation between a date sequence and upticks of a given equity is evaluated by the facility as follows: first, each date and time in the date sequence that is not within the trading hours of the equity's market is replaced with the closest future date and time that is within the market's (historic or scheduled) trading hours. Next, the date sequence is filtered to remove dates or times for which historic price data for the equity is missing. For example, a component date or time may be before the equity came into existence on the public market, or data may be missing due to incompleteness in the sourced database. Only equities with matched date sequences (as so adjusted for each equity) of a minimum positive length (e.g. at least 10 dates or times) are considered further. In some embodiments, the minimum positive length may be provided by a user or generated automatically by the facility based on, for example, an aggregation of date sequence match lengths (e.g., an average, a fraction or multiple of the average, the n-th longest match length, the n-th percentile of match lengths), and so on.

In some embodiments, a correlation score between the resulting date sequence and equity is computed as the weight-averaged increase in the market price of the equity on the dates or times in the date sequence, minus the weight-averaged increase in the market price of the equity on all dates between the earliest and latest dates or times in the date sequence. The weight used for weight-averaging is the dollar trading volume of the equity on each respective date. The facility thus normalizes the correlation score against overall moves in the equity's price; but (notably) it need not normalize for the overall move of the stock market in general.

In some embodiments, the facility identifies equities with a positive correlation score for further consideration. In the next step, the facility assures that the positive correlation does not arise from a single anomalous uptick. To accomplish this, the date sequence is sorted chronologically and split into two or more roughly equal date sequences. The number of subsequences into which a date sequence is split may be specified by a user or determined by the facility based on, for example, the overall length of the date sequence, the calculated correlation score, randomly, and so on. A correlation score is then computed against each portion of the date sequence; and only equities with a positive correlation in all (or a majority, e.g., more than 50%, 75%, 95%, etc.) of the portions of the date sequence are considered further. The facility can be configured to return at most the top N correlated equities, to maximize expected profit, while avoiding the generation of overly complex trading plans. In some implementations, N is typically in the range of 10 or 20; but may be adjusted for large investable cash amounts. In the final trading plan (i.e., a plan to be executed), it may make sense to invest all funds in the single top correlated equity associated with each date sequence; however, the profit opportunity computed for each correlated equity may be less than the investment cash, requiring the investment cash to be “spilled over” into other top-correlated equities.

In some embodiments, the facility then computes a confidence score to associate with each correlated equity relative to the date sequence. For this purpose, the facility assumes that the past dates or times, for which the equities price movement is known, is a random sample out of a theoretically infinite set of dates or times associated with similar events in the past and future. Taking the existing past data as a random sample, the facility applies the standard statistics Central Limit Theorem in order to compute the confidence that the Null Hypothesis does not apply. The Null Hypothesis is a standard concept in Statistics and the Central Limit Theorem. In this application the Null Hypothesis is taken to be the hypothesis that the (infinite) Date Sequence and (past and future) equity price movements have no correlation; and that the positive correlation computed in the past data was a statistical anomaly. The returned confidence level is the percent confidence that the Null Hypothesis does NOT apply and can be rejected—i.e. that there is a positive correlation between the Date Sequence and equity upticks, and that the positive correlation is expected to continue into the future.

The confidence score assesses the statistical confidence that a given (e.g., infinite) date sequence and a given equity's (past and future) price movements are positively correlated—not that they are as extremely positively correlated as in the past.

### Backtesting a Correlation and Trading Plan

A correlation (or theorized correlation) between a date sequence or time sequence and correlated equity upticks directly implies a trading plan for best exploiting the correlation. A trading plan generated by the facility schedules buy and sell trade actions for equities around their respective predicted upticks. At each date or time with a predicted uptick, the trading plan first chooses the top correlated equity, up to the maximum estimated opportunity (e.g., max_usd or max_shares) and creates a buy action and corresponding sell action for the equity for the predicted uptick and a corresponding sell action (e.g., a buy action at the beginning of the date sequence (or time sequence) and a sell action at the end of the date sequence (or time sequence)); if there is then left over investable cash at the given date or time, it “spills over” the cash, generating corresponding trade actions for subsequent top-correlated equities (e.g., buy actions at or near (e.g., market opening time) the beginning of each date or time in the sequence and sell actions at or near (e.g., market closing time) the end of each date or time in the sequence).

In some embodiments, the facility backtests a trading plan by simulating buy and sell trade actions vs. historic market price (taken as top market “bid” price when selling; or bottom market “ask” price when buying), for all trade actions in the trading plan. The facility then computes the compounding change in a simulated investment amount and returns the cash increase or decrease for each traded equity, as well as across all equities for a Merged Trading Plan.

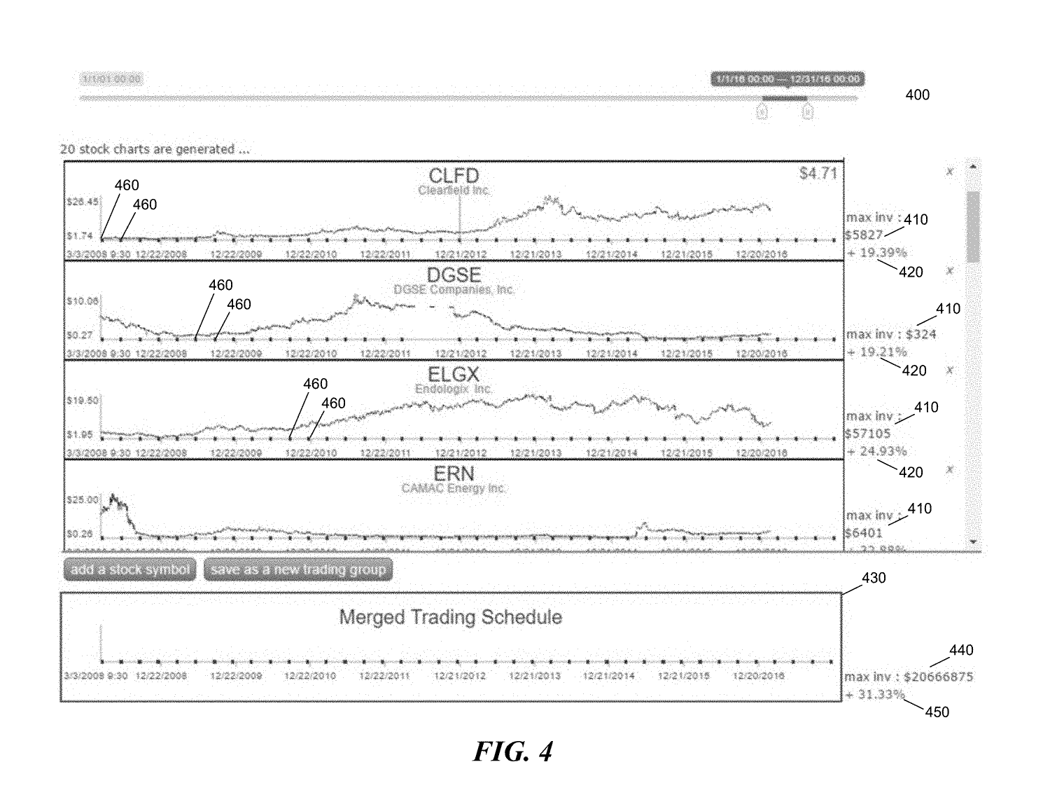

FIG. 4 is a page diagram 400 illustrating stock ticker charts for correlated stocks in accordance with some embodiments of the disclosed technology. In this example, the stocks represented are those found by the facility to be correlated with the dividend dates of Intel stock. Both past dates and future event dates (Intel stock dividend dates) are shown. For each correlated stock represented, the past ticker dates are shown, with event dates marked on the timeline (e.g., event date marks 460). Furthermore, for each correlated stock represented, the maximum estimated amount 410 that could have been profitably invested on the past event dates (estimated retrospective profit), to exploit the correlation, is shown; along with the estimated retrospective percent profit 420. Finally, a merged trading schedule 430 is shown at bottom, including the retrospective maximum investable amount 440 and estimated profit 450. Furthermore, for each correlated stock illustrated, FIG. 4 includes date marks 460, each date mark corresponding to a date in the date sequence (in this case, an Intel dividend date), and corresponding hold times of the indicated equity (e.g., an entire day for a pair of buy/sell actions associated with a particular day of a date sequence, an hour for a pair of buy/sell actions associated with a particular hour of a time sequence, and so on). Similarly, date marks are included in the merged trading schedule 430.

FIG. 5 is a page diagram 500 illustrating specific buy and sell trade actions 510 in accordance with some embodiments of the disclosed technology. In this example, each action is represented with a prescribed date and time, as generated by the facility so as to exploit the discovered correlation (of Intel dividend dates) with one of the correlated stocks. Trade actions for both past and future event dates are generated. Each buy action has associated the maximum estimated number of shares (“max_shares”) and US dollar amount (“max_usd”) that the facility determined could be applied to exploit the correlation. In this example, the trade actions are generated in a computable JSON script format, such that they can be ingested by an automated trading system, or merged and converted into a user's merged trading plan, although one of ordinary skill in the art will recognize that other formats may be used.

### Merging Trading Plans

In some embodiments, the facility allows for trading plans across multiple equities to be input and saved, whether they were generated manually, by the facility's built-in correlation engine, or by a separate system, etc. Once saved, multiple trading plans may be selected and merged; and the resulting merged trading plan can be saved under a new name.

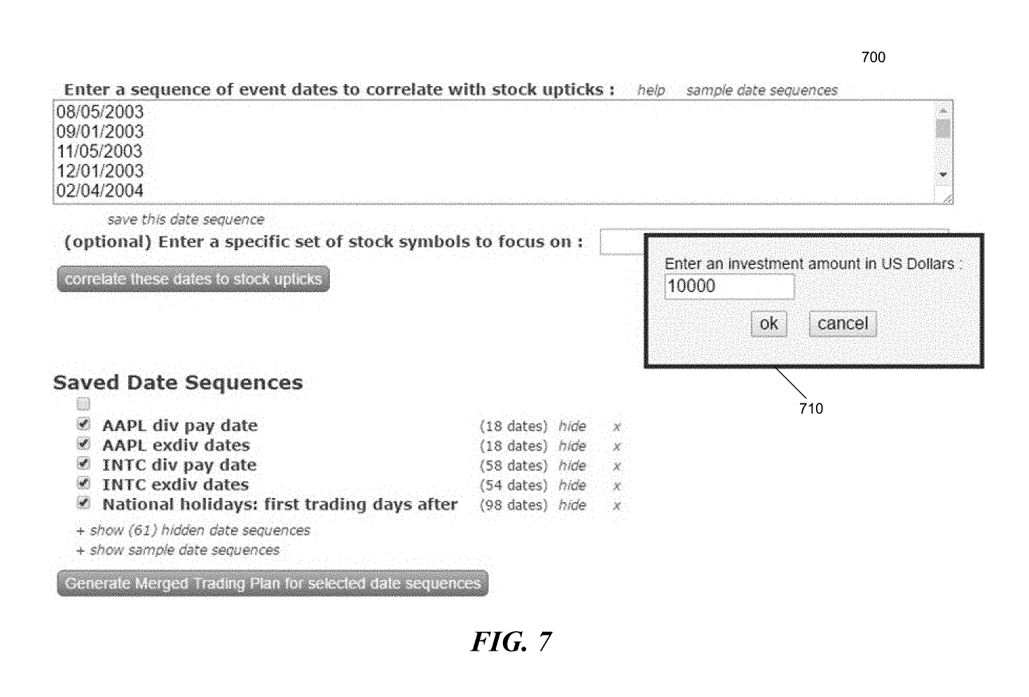

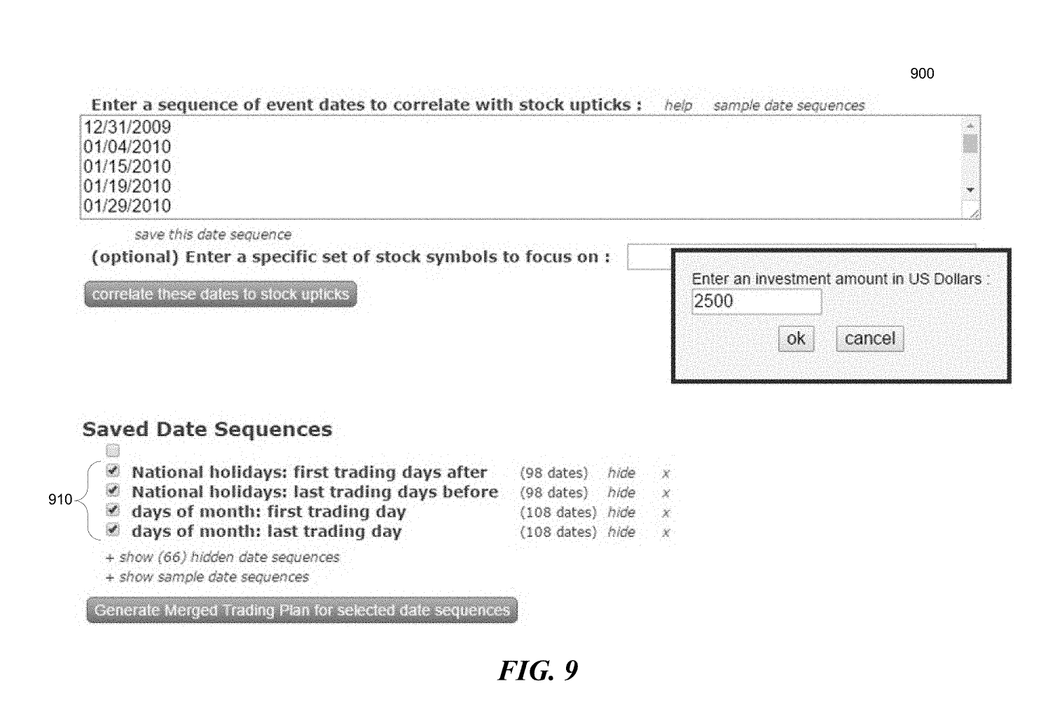

The mechanics of merging a set of multiple trading plans are as follows:
To merge a set of multiple trading plans, the facility takes as an input parameter the available investable cash for the final merged trading plan. This quantity may be explicitly entered by a user, as shown in FIGS. 7 and 9. In some embodiments, the quantity of investable cash may be assumed as the sum of the investable cash amounts associated with the component trading plans.
For days when no component trading plan includes trade actions (buy or sell actions) for a given equity, then trivially the merged trading plan also includes no trade actions.
If, for a given trading day, only one component trading plan includes trade actions, then the merged trading plan is assigned the identical trade actions for the same equities, at the same dates and times, and with identical trade limits (“max_shares” and “max_usd”).
If, for a given trading day, multiple component trading plans include trade actions, then the merged trading plan is assigned the union of the trade actions from the component trading plans for that day, with two adjustments:
   a. If two component trading plans include “hold times” (time between the buy and sell action for a given equity) which overlap chronologically, then the “hold times” are combined, such that the merged “hold time” is implemented as a single buy and single sell trade action, at the beginning and end of the merged “hold time,” respectively.
   b. If the sum of maximum investable cash for “hold times” of trade actions of component trading plans, at a given point in time, is more than the investable cash parameter for the merged trading plan, then in the merged trading plan the maximum investable cash (“max_usd”) of some or all associated buy actions is reduced minimally such that the sum of all “hold times” overlapping the point in time in the merged trading plan is at most the investable cash parameter. In some embodiments, reduction may be proportional, or may preferably reduce the maximum cash invested in equities derived from component trading plans with lower associated correlation or confidence scores.
      This process of merging multiple trading plans into a single new merged trading plan may be repeated. Given a large set of component trading plans, generated from correlations with disparate date sequences, the ultimate merged trading plan may be extremely “dense,” with very frequent trade actions. If the component trading plans are derived from valid correlations with date sequences, whose positive correlation continues into the future, then by frequently moving invested cash (and accruing profits) between various profit opportunities, the resulting merged trading plan may be highly efficient in optimizing the exploitable profit potential of invested cash.

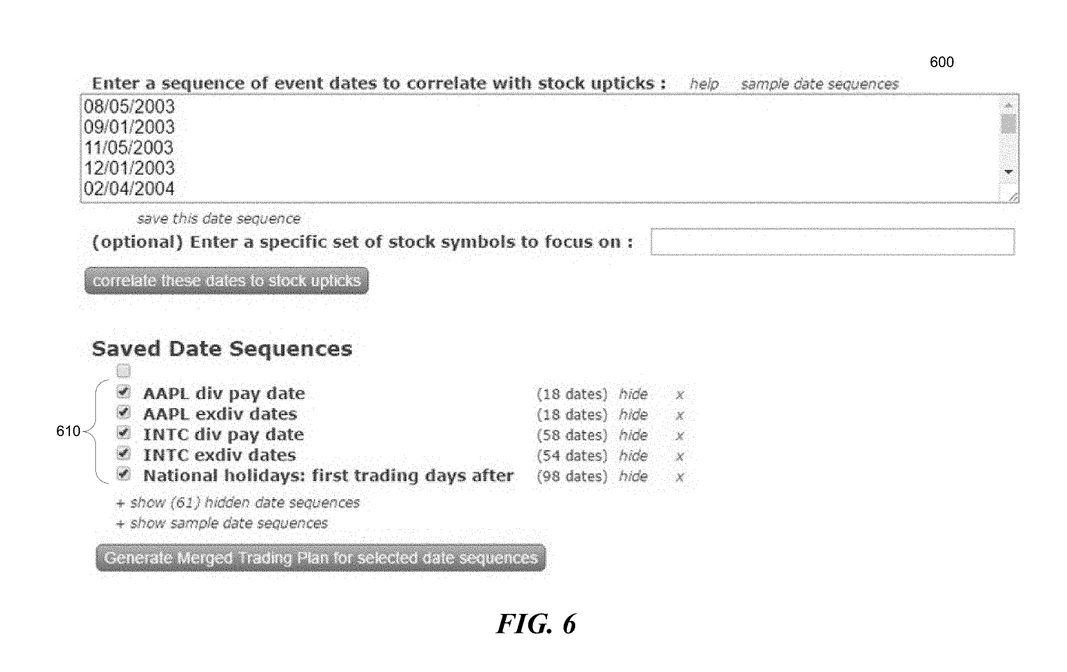

FIG. 6 is page diagram 600 illustrating the selection of multiple date sequences 610 in accordance with some embodiments of the disclosed technology. In this case, each of the dates (e.g., Apple dividend pay dates, Intel ex-dividend dates, first trading date after a national holiday, etc.) is to be correlated separately by the facility into a trading plan, with those trading plans then merged so as to provide a dense trading plan that moves investment cash so as to optimize the exploitation of all correlations associated with the input date sequences.

FIG. 7 is a page diagram 700 illustrating a prompt 710 by the facility for the user to enter the investable cash for which the merged trading plan is to be optimized in accordance with some embodiments of the disclosed technology. Since the exploitable investment opportunity for each individual stock may be limited, the facility uses the user's input investment amount to compute how many top-correlated stocks are to be included in the merged trading plan, so as to utilize a maximum amount of the investable cash.

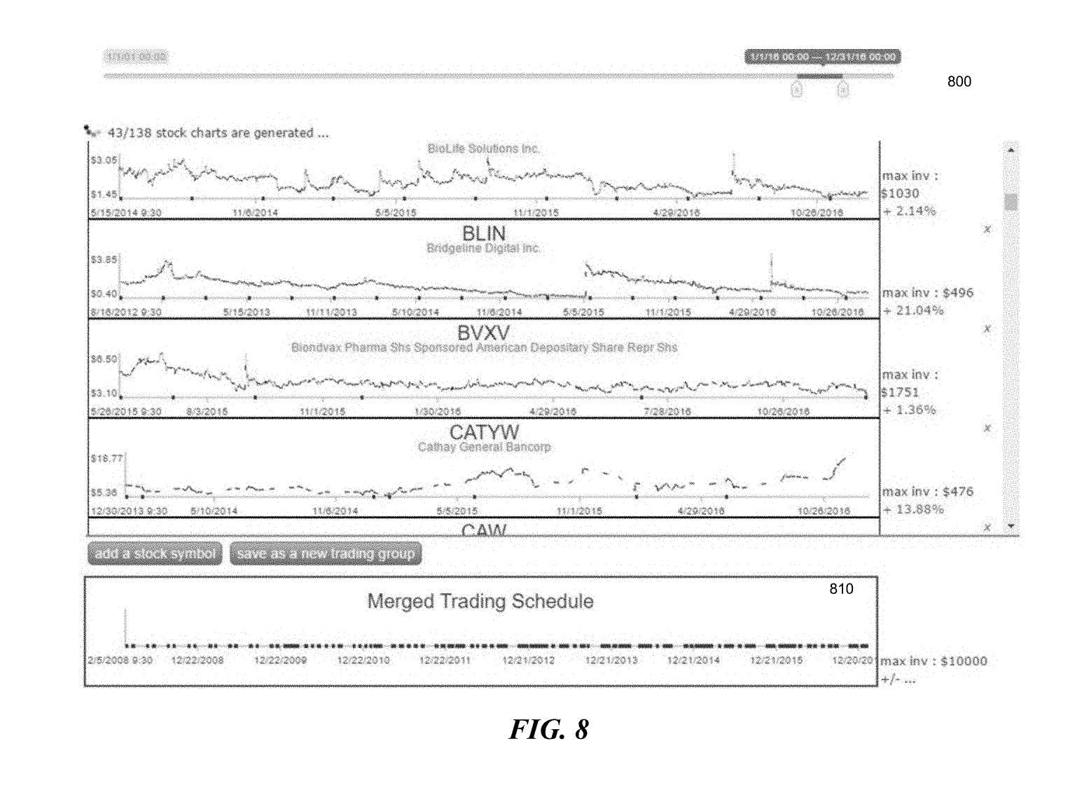

FIG. 8 is a page diagram 800 illustrating trading plans for multiple stocks and a merged trading plan 810 in accordance with some embodiments of the disclosed technology. This example includes 5 date sequences (as shown in FIG. 6) and a user-provided investable cash amount (as shown in FIG. 7). Because 5 date sequences were input, and their 5 associated trading plans are being merged, the merged trading plan is much more “dense” (with more frequent buy and sell actions (each represented by date mark)) than the trading plans for any of the component date sequences, so as to more optimally grow a fixed investment amount.

FIG. 9 is a page diagram 900 illustrating the selection of 4 date sequences 910 in accordance with some embodiments of the disclosed technology. In this example, each date sequence is predictable far in advance (dates relative to holidays and days of the month). Each of the date sequences is to be correlated separately by the facility into a trading plan, with those trading plans then merged so as to provide a dense trading plan that moves the displayed selected quantity of investment cash so as to optimize the exploitation of all correlations associated with the input date sequences.

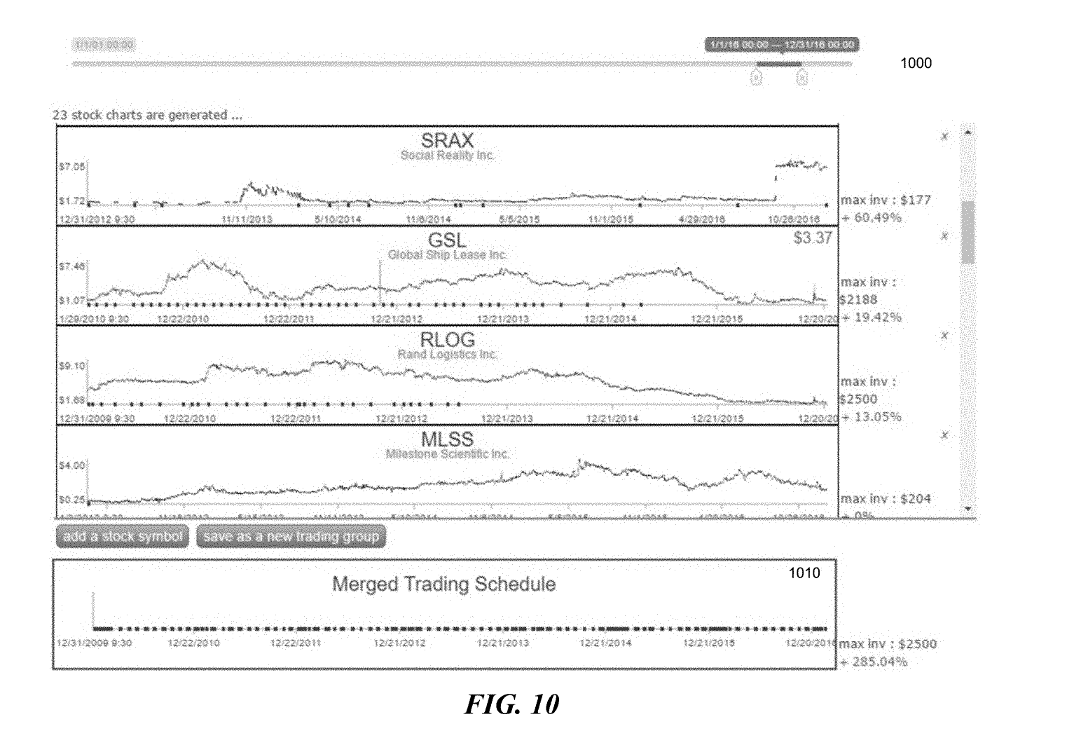

FIG. 10 is a page diagram 1000 illustrating a merged trading plan 1010 in accordance with some embodiments of the disclosed technology. This example illustrates a merged trading plan for the 4 date sequences and invested amount from FIG. 9. The estimated retrospective profit for each component stock, and for the merged trading plan, is displayed. Because 4 date sequences were input, and their 4 associated trading plans were merged, the merged trading plan is much more “dense” (with more frequent buy and sell actions) than the trading plans for any of the component date sequences, so as to more optimally grow a fixed investment amount.

FIG. 11 is a page diagram 1100 illustrating specific buy and sell trade actions 1110 in accordance with some embodiments of the disclosed technology. In this example, each trade action has an associated prescribed date and time, as generated by the facility so as to exploit the discovered correlations for the date sequences in FIGS. 9 and 10. Trade actions for both past and future event dates are generated. Each buy action has associated the maximum estimated number of shares (“max_shares”) and US dollar amount (“max_usd”) (one of ordinary skill in the art will recognize that any currency may be used) that the facility determined could be applied to exploit the correlation. The trade actions can be generated in a computable JSON script format, such that they can be ingested by an automated trading system, or merged and converted into a user's merged trading plan.

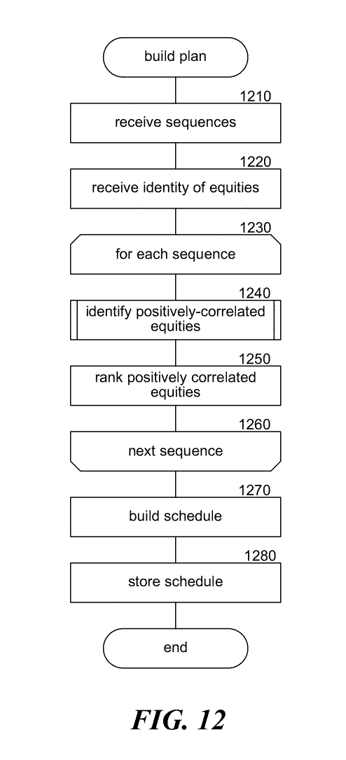

FIG. 12 is a flow diagram illustrating the processing of a build trading plan component in accordance with some embodiments of the disclosed technology. The component is invoked by the facility to build a trading plan given a set of sequences (e.g., date sequences and/or time sequences). In block 1210, the component receives the sequences—such as a set of sequences provided by or entered by a user, or a set of automatically generated sequences based on a triggering event, such as a predictable event—which may include both past and future dates or times. In block 1220, the component receives a set of identified equities, such as a set of equities specified by a user, a set of equities trading on a particular market or markets, and so on. In blocks 1230-1260, the component loops through each sequence to identify equities that are positively-correlated with that sequence and then ranks the correlated equities. In block 1240, the component invokes an identify positively correlated equities component to identify equities that have upticks that are positively-correlated with the currently selected sequence. In block 1250, the component ranks the identified equities based on a correlation score. In block 1260, if there are sequences yet to be analyzed, then the component selects the next sequence and loops back to block 1230 to process the next sequence, else the component continues at block 1270. In block 1270, the component builds a schedule for the trading plan by, for each sequence, creating a set of buy and sell actions for each positively correlated equity based on max_shares and/or max_usd value associated with the trading plan and/or equity and the user's maximum amount of the investable cash (each of these values may be received by facility prior to generating the plan and/or collected by the component via one or more user prompts). For example, if the component finds a positive correlation between upticks of three different equities on Jul. 5, 2016-Jul. 8, 2016 (past dates) (where this sequence of dates corresponds to the four trading days on a particular market after a triggering event (national holiday)), the component may generate a plan that includes trading actions to buy each of the three equities on the morning of corresponding future dates (i.e., the first four trading days after the same national holiday the following year, in this case Jul. 5, 2017-Jul. 7, 2017 and Jul. 10, 2017) and sell each of the three equities just before market close on those dates. If the amount of investable cash is insufficient to purchase at least max_usd or max_shares of each of the equities, then the component may allocate the amount of investable cash across each of the shares based on, in some cases, the correlation values for the corresponding sequence and equity. In block 1280, the component stores the schedule for execution and/or modification.

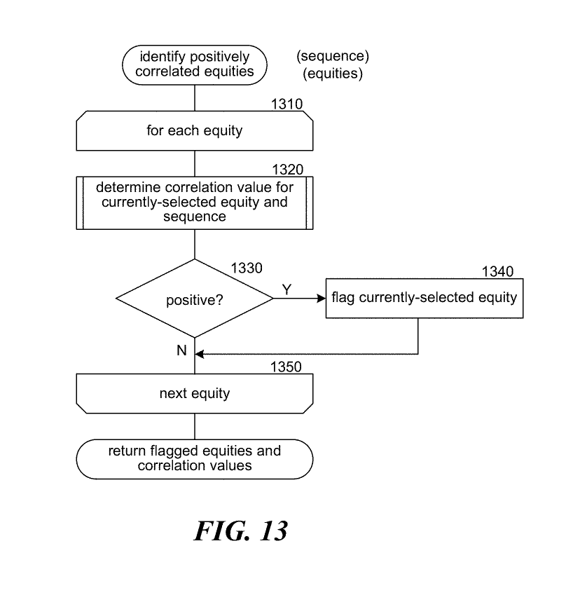

FIG. 13 is a flow diagram illustrating the processing of an identify positively correlated equities component in accordance with some embodiments of the disclosed technology. The component is invoked by the build trading plan component to identify equities from among a group of equities having upticks that are positively-correlated with a particular sequence (or portion thereof). In blocks 1310-1350, the component loops through each equity to determine whether the equity is positively correlated with the sequence. In block 1320, the component invokes a determine correlation value for the currently-selected equity and the sequence. In decision block 1330, if the determined correlation value is positive, then the component continues at block 1340, else the component continues at block 1350. In block 1340, the component flags the currently-selected equity as having upticks that are positively-correlated with the sequence. In block 1350, if there are equities yet to be analyzed, then the component selects the next equity and loops back to block 1310 to process the next equity, else the component returns the set of flagged equities.

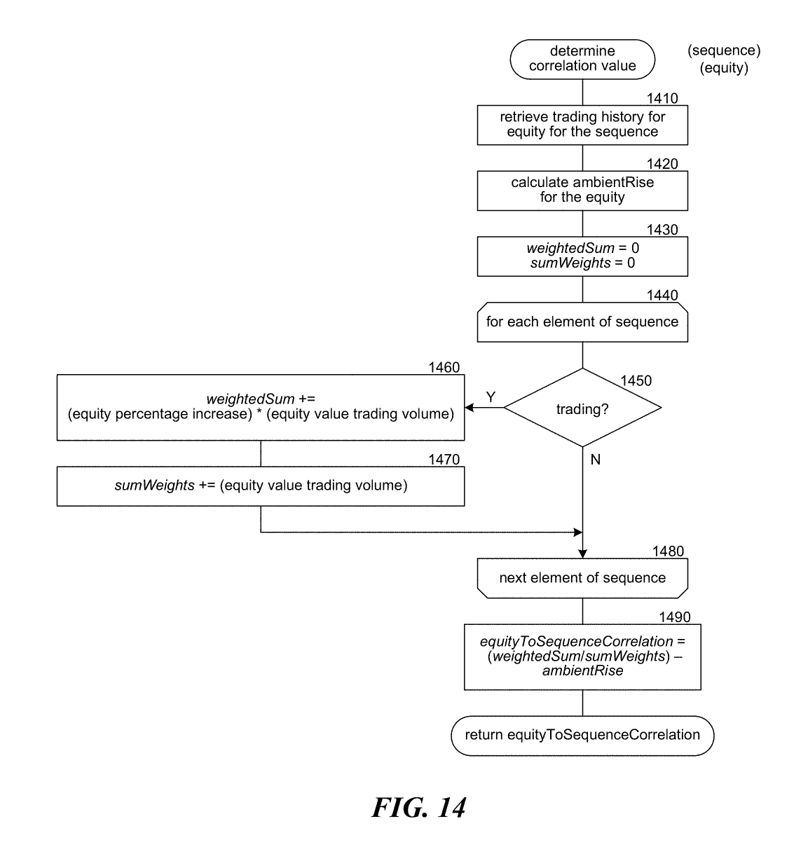

FIG. 14 is a flow diagram illustrating the processing of a determine correlation value component in accordance with some embodiments of the disclosed technology. The determine correlation value component is invoked by an identify positively correlated equities component to calculate a correlation value for an equity and a sequence (equity-sequence pair). In block 1410, the component retrieves trading history information for the equity for any past elements of the sequence (e.g., past dates or times). For example, the component may retrieve this information from a third party equity information repository that provides past trading and/or other market information for one or more equities, such as NASDAQ.COM, GOOGLE FINANCE, etc. In block 1420, the component calculates an ambientRise value for the equity-sequence pair as the percentage increase in price from open of the first (earliest) past element of the sequence to close of the last (latest) past element of the sequence. In block 1430, the component initializes two variables, weightedSum and sumWeights, to 0. In blocks 1440-1480, the component loops through each past trading element of the sequence to calculate weightedSum and sumWeights values for the equity-sequence pair. In decision block 1450, if the currently-selected element is a trading date or time (i.e., if the corresponding equity was subject to being traded on that date or time because, for example, the corresponding market was open on), then the component continues at block 1460, else the component continues at block 1480. In block 1460 the component increments the weightedSum value by the product of 1) the percentage by which the value or price of the equity increased during the currently-selected element (i.e., date or time) and 2) an indication of the trading volume of the equity during that element (e.g., total number of shares exchanged, total number of shares times average price of equity during that element, total dollar amount exchanged for that equity during that element). In block 1470, the component increments the weightedSum value by the indication of the trading volume of the equity during the currently-selected element. In block 1480, if there are any past elements of the sequence yet to be analyzed, then the component selects the next past element of the sequence and loops back to block 1440 to process the next element, else the component continues at block 1490. In block 1490, the component calculates a correlation value for the equity-sequence pair and then returns the calculated correlation value.

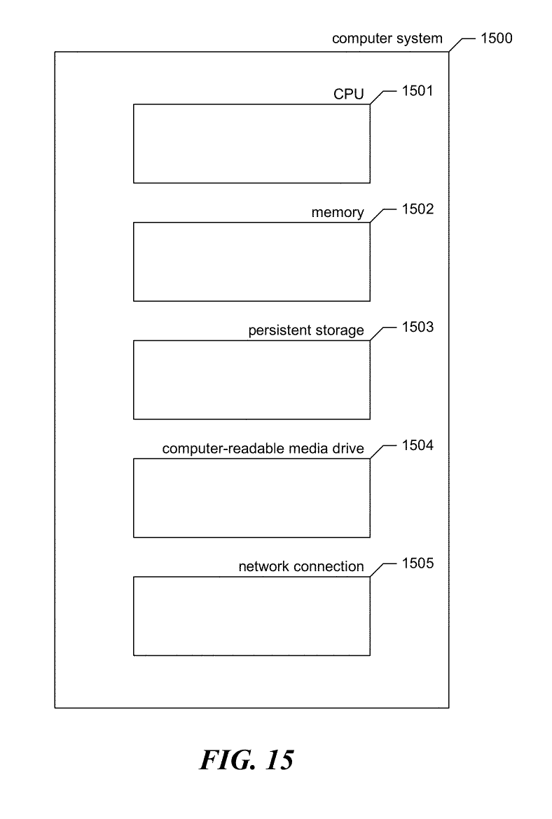

FIG. 15 is a block diagram showing some of the components typically incorporated in at least some of the computer systems and other devices on which the facility executes. These computer systems and devices 1500 may include one or more central processing units (“CPUs”) 1501 for executing computer programs; a computer memory 1502 for storing programs and data—including data structures—while they are being used; a persistent storage device 1503, such as a hard drive, for persistently storing programs and data; a computer-readable media drive 1504, such as a CD-ROM drive, for reading programs and data stored on a computer-readable medium; and a network connection 1505 for connecting the computer system to other computer systems, such as via the Internet, to exchange programs and/or data—including data structures. While computer systems configured as described above are typically used to support the operation of the facility, one of ordinary skill in the art will appreciate that the facility may be implemented using devices of various types and configurations, and having various components.

In various examples, these computer systems and other devices can include server computer systems, desktop computer systems, laptop computer systems, netbooks, tablets, mobile phones, personal digital assistants, televisions, cameras, automobile computers, electronic media players, and/or the like. In some embodiments, the facility may operate on specific-purpose computing systems, such as an ASIC, and so on. In various examples, the computer systems and devices include one or more of each of the following: a central processing unit (“CPU”) configured to execute computer programs; a computer memory configured to store programs and data while they are being used, including a multithreaded program being tested, a debugger, the facility, an operating system including a kernel, and device drivers; a persistent storage device, such as a hard drive or flash drive configured to persistently store programs and data; a computer-readable storage media drive, such as a floppy, flash, CD-ROM, or DVD drive, configured to read programs and data stored on a computer-readable storage medium, such as a floppy disk, flash memory device, CD-ROM, or DVD; and a network connection configured to connect the computer system to other computer systems to send and/or receive data, such as via the Internet, a Local Area Network (LAN), a Wide Area Network (WAN), a point-to-point dial-up connection, a cell phone network, or another network and its networking hardware in various examples including routers, switches, and various types of transmitters, receivers, or computer-readable transmission media. While computer systems configured as described above may be used to support the operation of the facility, those skilled in the art will readily appreciate that the facility may be implemented using devices of various types and configurations, and having various components. Elements of the facility may be described in the general context of computer-executable instructions, such as program modules, executed by one or more computers or other devices. Generally, program modules include routines, programs, objects, components, data structures, and/or the like configured to perform particular tasks or implement particular abstract data types and may be encrypted. Furthermore, the functionality of the program modules may be combined or distributed as desired in various examples. Moreover, display pages may be implemented in any of various ways, such as in C++ or as web pages in XML (Extensible Markup Language), HTML (HyperText Markup Language), JavaScript, AJAX (Asynchronous JavaScript and XML) techniques, or any other scripts or methods of creating displayable data, such as the Wireless Access Protocol (WAP). Typically, the functionality of the program modules may be combined or distributed as desired in various embodiments, including cloud-based implementations, web applications, mobile applications for mobile devices, and so on.

The following discussion provides a brief, general description of a suitable computing environment in which the disclosed technology can be implemented. Although not required, aspects of the disclosed technology are described in the general context of computer-executable instructions, such as routines executed by a general-purpose data processing device, e.g., a server computer, wireless device, or personal computer. Those skilled in the relevant art will appreciate that aspects of the disclosed technology can be practiced with other communications, data processing, or computer system configurations, including: Internet appliances, hand-held devices (including personal digital assistants (PDAs)), wearable computers (e.g., fitness-oriented wearable computing devices), all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably herein, and refer to any of the above devices and systems, as well as any data processor.

Aspects of the disclosed technology can be embodied in a special purpose computer or data processor that is specifically programmed, configured, or constructed to perform one or more of the computer-executable instructions explained in detail herein. While aspects of the disclosed technology, such as certain functions, are described as being performed exclusively on a single device, the disclosed technology can also be practiced in distributed computing environments where functions or modules are shared among disparate processing devices, which are linked through a communications network such as a Local Area Network (LAN), Wide Area Network (WAN), or the Internet. In a distributed computing environment, program modules may be located in both local and remote memory storage devices.

Aspects of the disclosed technology may be stored or distributed on tangible computer-readable media, including magnetically or optically readable computer discs, hard-wired or preprogrammed chips (e.g., EEPROM semiconductor chips), nanotechnology memory, biological memory, or other computer-readable storage media. Alternatively, computer-implemented instructions, data structures, screen displays, and other data under aspects of the disclosed technology may be distributed over the Internet or over other networks (including wireless networks), on a propagated signal on a propagation medium (e.g., electromagnetic wave(s), sound wave, etc.) over a period of time, or they may be provided on any analog or digital network (packet switched, circuit switched, or other scheme). Furthermore, the term computer-readable storage medium does not encompass signals (e.g., propagating signals) or transitory media.

Those skilled in the art will appreciate that the facility may be implemented in a variety of environments including both a distributed environment and a single, monolithic computer system, as well as various other combinations of computer systems or similar devices connected in various ways.

Compatibility with Other Investment Strategies

In some embodiments, the facility emphasizes the value of equity uptick predictions in short time periods, resulting in trading plans with short “hold times.” Even with a densely-merged merged trading plan (where density connotes highly frequent trading actions, such as trading actions that exceed a predefined threshold (e.g., 10 trading actions per week, 100 trading actions per month defined by, for example, a user or the facility), there is therefore a high likelihood of “down” periods during which the merged trading plan does not prescribe holding any equity during some open-market time (or, that it prescribes investing less at the given time than the available compounded investable cash for the trading plan). During these “down” periods, the investable cash may be applied to any other purpose. For example, it can be invested in a trading plan arising from a wholly different technique, possibly unrelated to the facility. Or, the investable cash may be directed to a safe traditional investment instrument during the “down” times—such as a mutual fund, or a stable equity.

The trading plans generated by the facility are therefore compatible with, and concurrently executable with, any other time-flexible investment strategy.

### Testing a Correlation and Trading Plan in Simulation

Even if a trading plan shows high profitability in the past, and the associated correlation scores and confidence scores are high, it may be insufficient to justify investing real money in the trading plan's future trade actions. This is especially true if the component correlations were found by matching date sequences against ALL equities (e.g. all publicly traded stocks); as opposed to being validated as positive correlations against select stocks, based on a user's market insight. This is because, given the large number of equities (e.g. over 8000 publicly traded stocks on the major US exchanges), almost any date sequence will be found to be positively correlated with upticks of some (i.e., at least one) equity.

In some embodiments, following a successful backtest, it is therefore desirable to “forward test” a trading plan; that is, to watch it execute—still with simulated funds—in real-time. The desire is, at some given time, to “lock down” the trading plan from that time; and, going forward, to evaluate it in simulation, not just from the beginning of its associated date sequence, but since the “lock down” date; without allowing any adjustment or “correction” of dates in the date sequence. Locking a trading plan down, however, presents a problem when the underlying event sequence is not predictable far into the future. For example, if the underlying event sequence is the dividend dates of a stock, and those are only announced two months in advance, then a fully “locked down” trading plan is only “forward testable” for about 2 months. If the underlying event sequence is even less predictable—for example “days it is rainy in Manhattan”—then an associated fully “locked down” trading plan is only “forward testable” for a few days (e.g., the prediction time of a weather report). The facility therefore allows a trading plan to be locked in an “append-only” mode. In this mode, a trading plan is dynamic, in that trade actions may be added for the future, but may not be changed in the past. Critically, an “append-only” locked trading plan allows updates only in the future relative to the time of an attempted change—not just relative to the lock date. Therefore, there can be no correction of trade actions for a given date and time after the market price move for the date and time is known; only future trade actions may be added, based on evolution of the component date sequences (i.e., the date sequences that went into creating the corresponding trading plan).

When a dynamic trading plan is locked for “append-only,” its association with underlying date sequences is internally retained. Also, the association between date sequences and correlated equities in the trading plan is internally retained. The underlying date sequences may continue to evolve, as new associated event dates and times are announced or scheduled. For example, if date sequences are selected for a trading plan based on product release dates and a company announces a release date for a new product (or new version), then a new date or set of dates can be added to the date sequences, with resulting trading actions added to the trading plan (or a new trading plan constructed based on the new date sequences). At the time that a trading plan is constructed or re-computed, the current time is internally recorded as the last-update time. After it is locked for “append-only,” the facility monitors the last-update time of each component date sequence, relative to the trading plan's last-update time. If at any time, a component date sequence's last-update time is after the “append-only” locked trading plan's last-update time, the trading plan is displayed as “stale,” and in need of re-computation. For example, if a trading plan is created from a date sequence of a given firm's dividend dates, and the firm then announces its next dividend date, then that trading plan is “stale” until the newly announced dividend date is also incorporated. In some implementations, the re-computation of a “stale” trading plan is automatic and immediate. In the re-computation of an “append-only” locked trading plan, there is no re-computation of correlation; i.e. there is no new learning from past data, even from past data since the lock date. Only new future trade actions are added, from new dates appended to the component date sequences, for the same equities previously identified by the facility as having upticks correlated with the date sequences, respectively.

The facility's “append-only” lock mode for dynamic trading plans assists in managing validation of trading plan's predictive power—and market validity of underlying date sequences and purported correlations—on a large scale. This is especially true when merged trading plans are developed in collaboration with large or loosely-coupled groups of researchers, where some parties may be less trusted or untrusted.

### Managing New Events in Real-Time

In some embodiments, re-computation of a trading plan in response to an updated date sequence is useful when the date sequence models events that occur suddenly, with little or no prediction possible. For example, a date sequence may include dates that a terrorist incident occurred somewhere in the US. When suddenly a terrorist incident occurs, that date sequence can be updated to include the current date, and then all associated trading plans immediately re-calculated. In the context of many date sequences, with many inter-related trading plans, this auto-recomputation aspect of the facility enables many trading plans—and associated market trading driven by them—to respond dynamically to unexpected world events.

### Sharing and Collaboration

As an aspect of its support for scaled development of merged trading plans, the facility allows for the sharing of date sequences and trading plans between users who have linked to each other via, for example, a website hosted by the facility. These items may be individually marked as “shared.” When users link to each other as collaborators only their “shared” items are viewable by the other party; and only in read-only mode by the non-owning party. However, any read-only item may be easily copied and re-saved by the non-owning user, as his own item. Furthermore, a user may select multiple trading plans, including ones owned by his collaborators, and merge them into a merged trading plan owned by that user.

### Validating a Correlation and Dynamic Trading Plan Created by an Untrusted Party

The disclosed facility and techniques allow for an unprecedented level of scaled collaboration in developing and merging equity trading strategies and plans. It thus allows for new business models, in which researchers have a looser relationship to the central managers than the traditional employee-manager relationship.

The facility may operate in an environment where researchers work as independent contractors, or even independently as users of a website. The users may be data scientists, who research market correlations part-time, using the website's tools. The contributing researchers may submit their discovered market-relevant date sequences, correlations, and resulting trading plans, for validation by the central managers. Once validated, a trading plan may be merged into a merged trading plan, according to which a firm's real money is invested.

As described, the disclosed facility allows for the discovery and backtesting of correlations between events (date sequences) and equity upticks—even by non-programmers and non-data scientists. The disclosed facility facilitates the construction of trading plans from those correlations and the (infinite) merging of multiple trading plans, such that a resulting merged trading plan may represent the total research of an individual researcher or team; or of many researchers or of many teams. The disclosed facility further facilitates the sharing of trading plans and the locking of trading plans in, for example, an “append-only” mode, such that a trading plan can be shared for validation (“forward testing”) by, for example, central managers—even while the component date sequences are maintained by the owning researchers (or automatically). Furthermore, the disclosed facility may evaluate the performance of a locked trading plan since the lock date—for easy, trusted validation by the central managers. The disclosed facility can also produce trade actions of a (merged) trading plan as computable script, for easy execution by an automated trading system.

Custom Trading Advice with Performance Tracking

In some embodiments, the facility provides for automated custom trading guidance, optionally with tracking of its effectiveness. A trading plan generated by the facility has an explicit limited investment potential. As such, if a brokerage or investment consulting service were to offer trading advice to a client (or assume trading for a client) based on a trading plan, it could not re-use the same trading plan for an unlimited number of clients. Each trading plan's projected investment potential would need to be “metered out” based on the clients' respective applied account funds, to the limit of the trading plan's investment potential. Therefore, to a degree, the per-client advice (or trading on behalf of the client) would be customized. Unlike traditional investment advice, however, a trading plan is completely specified and deterministic. Traditional trading advice of the form “diversify away from this” or “you should consider tech stocks,” is not well-defined and, as such, cannot be retroactively determined as having been “good” or “bad”—because the client may reasonably interpret it in various ways, applying the advice to various equities, at various times, and in various investment amounts.

The trading plan, on the other hand, is completely specified. If advice is given to follow a given (merged) trading plan, then at some given time in the future, that advice can be judged deterministically in the future as having been “profitable” or “not profitable,” by backtesting the trading plan in simulation from the date the advice was given to the given future time. The facility allows anyone with access to the trading plan to perform this backtesting. The advice might be wholly automated; or human-delivered but with the associated trading plan auto-recorded. A consulting fee might be calculated based on the effectiveness of the trading plan. For example, if the trading advice, as backtested from the time of the advice to the last trade action in the trading plan, were retroactively computed as “not profitable,” then a consulting fee might be refunded. This would be a lofty goal for a brokerage or consulting firm—only charging for “good” advice. But this is only possible if investment advice can be deterministically evaluated as “good” vs “bad.”

### Isolation of Intellectual Property

In some embodiments, the facility also provides for the sequestering of “intellectual property” (e.g., a researcher's curated set of date sequences and/or trading plan, etc.). The intellectual property in question is predictive market insight, in the form of the future correlation between an event sequence (date sequence) and above-market upticks of specific equities. Critical to this understanding is that a date sequence is generated by some understanding and connection to real-world events; and in general, for non-trivial date sequences, the next date in the date sequence is not easily discernable from viewing previous dates. For example, a date sequence may be defined as “first open trading day after an Islamic holiday that is observed in Iraq.” Hypothetically, some oil stock's upticks may be correlated to this date sequence, making it a market-relevant date sequence. The correlation of this date sequence with the oil stock may be calculated from a long, multi-year, segment of the date sequence. However, from a short segment of the date sequence (say, only a month or two), it would be difficult to determine the significance of the dates in the sequence; or to predict the next date beyond the visible segment. Similarly, someone observing trade actions of a trading plan, whose dates are determined from a running segment of this date sequence, would have difficulty anticipating the next trade action of the trading plan given a relatively brief observation time.

In the ordinary equity trading world, quite often the trading activity of large individual investors or investment firms becomes public after the fact. However, knowing the past trading activity of a successful investor does not in general enable one to reproduce their success in the future for oneself. The reason is that conditions of the market are ever-changing. Conditions in the future will not be sufficiently similar to those of the past such that simply repeating a past trade sequence is likely to be profitable. The successful investor's trading activity does not disclose the insights and decision logic that went into the trade actions. The trade actions obscure an enormous volume of information, decision logic, and intelligence which produced them.

Similarly, the facility's constructs do not disclose critical intellectual property to those with which it is not explicitly shared. Just as past trading actions do not disclose the intellectual property that produced them, a trading plan of the facility does not disclose the intellectual property that produced either its past or future trade actions. Of course, anyone viewing a trading plan with future trade actions may act independently to trade identically on his own behalf. However, if it is a dynamic trading plan (regularly re-computed from evolving date sequences), then trade actions beyond the horizon of the current trading plan cannot in general be predicted. This is especially true of a high-scale merged trading plan, comprised of tens or hundreds of individual trading plans over many independent date sequences. The individual date sequences and generating event sequences would be inscrutably lost within the merged trade actions. Some analogy might be attempted with identifying component frequencies from a mixed signal (as in acoustics). There are known high-tech solutions for identifying component frequencies in a mixed signal that are *regular* and periodic—such as FFT (Fast Fourier transform). However, the component date sequences of a merged trading plan are in general not regularly periodic. An independent researcher is therefore protected from having intellectual property stolen by the central managers, as the central managers validate (“forward test”) the researcher's submitted merged trading plan. Thus, while central managers can “front-run” the submitted trading plan's near-term trade actions (inserting their own equity purchases ahead of the researcher's), they do not have access to the logic that generates the component date sequences and, therefore, cannot take advantage of the trading plan (the researcher's intellectual property) indefinitely. (The researcher may choose to purposely curtail the generation of new dates into component date sequences, even if predictable far in advance, so as not to disclose the resulting trade actions far into the future).

Similarly, the researcher is not able to steal the intellectual property of other researchers. In a research scenario with many loosely-connected researchers collaborating, it would be disastrous if a single researcher could quit and take a firm's entire intellectual property (non-disclosure agreements and such legal remedies may have little ameliorative effect, for the same reason that trading activity does not disclose IP—the thieving researcher could trade on the stolen market insights, without his trades being provably traceable to the stolen IP). The disclosed facility allows for researchers to remain siloed—such that each researcher is fully empowered and contributory, but none is able to discern the intellectual property generated by other researchers, even upon viewing their collaborated-upon merged trading plans.

From the foregoing, it will be appreciated that specific embodiments of the invention have been described herein for purposes of illustration, but that various modifications may be made without deviating from the scope of the invention. Accordingly, the invention is not limited except as by the appended claims.

I claim:

1. A method, performed by a computing system having a memory and a processor, for generating a trading plan, the method comprising:
receiving, by the processor, a plurality of sequences;
for at least two sequences of the received plurality of sequences,
identifying, by the processor, from among a set of equities, two or more equities having upticks that are positively correlated with the sequence,
ranking, by the processor, the identified equities that are positively correlated with the sequence, and
for at least two of the ranked equities,
generating, by the processor, a trading plan for the equity based at least in part on the sequence; and
merging, by the processor, two or more of the generated trading plans to produce a merged trading plan.

2. The method of claim 1, wherein at least one of the sequences is a date sequence that includes a date of a past event, wherein at least one of the sequences is a date sequence that includes a date of a future event, and wherein at least one of the sequences is a time sequence that includes a time of a past event and a time of a future event.

3. The method of claim 1, wherein identifying, from among the set of equities, one or more equities positively correlated with a first date sequence comprises:
for each equity of the set of equities,
calculating a correlation value for the equity and the first date sequence.

4. The method of claim 3, wherein calculating a correlation value for a first equity and the first date sequence comprises:
retrieving trade history information for the first equity, wherein the first date sequence includes two or more trading dates;
determining, for the first equity, an ambient rise over the first date sequence;
for each trading date of the first date sequence,
determining, for the first equity, a percentage increase in valuation for the trading date, and
determining, for the first equity, a trading volume for the trading date; and
calculating the correlation value for the first equity and the first date sequence based at least in part on:
the determined percentage increases in valuation,
the determined trading volumes, and
the determined ambient rise over the date sequence.

5. The method of claim 3, further comprising:
for each equity of the set of equities,
calculating a confidence score for the equity and the first date sequence at least in part by:
retrieving trade history information for the first equity, wherein the first date sequence comprises a start date and an end date,
determining a percentage change in price of the equity for each date in the trade history information from the start date to the end date,
determining an average percentage change based at least in part on the determined percentage changes,
determining a date sequence percentage change in price of the equity for each date in the date sequence, and
determining an average date sequence percentage change based at least in part on the determined date sequence percentage changes,
wherein the confidence score for the equity and the first date sequence is based at least in part on:
the determined average percentage change, the determined average date sequence percentage, and an error function.

6. The method of claim 1, wherein at least one of the date sequences includes for at least one date, a sequence of multiple times for the at least one date.

7. The method of claim 1, wherein generating a trading plan for a first time sequence of the received plurality of sequences comprises:
for each identified equity having an uptick that is positively correlated with the first time sequence,
creating, within the trading plan for the first time sequence, a buy action associated with a time of the first time sequence, and
creating, with the trading plan for the first date sequence, a sell action associated with a time of the first time sequence;
executing, by the computing system, at least one of the created buy actions at least in part by causing a corresponding equity to be purchased on behalf of a first user; and
executing, by the computing system, at least one of the created sell actions at least in part by causing a corresponding equity to be sold on behalf of the first user.

8. A computing system for generating a trading plan, the computing system comprising:
a memory;
a processor;
a component configured to receive, from a user, a selection of sequences of dates or times associated with past and future events;
a component configured to correlate one or more of the received sequences of dates or times against upticks of one or more equities, each correlation being numerically scored for intensity and confidence;
a component configured to provide, to the user, an indication of the top-scored equities; and
a component configured to construct a trading plan, as a group of equities and thoroughly-specified buy and sell trading actions for each equity, with specific time and amount of each trading action based at least in part on:
the correlations of the one or more received sequences of dates or times, and the upticks of the one or more equities,
wherein each component comprises computer-executable instructions stored in the memory for execution by the computing system.

9. The system of claim 8, further comprising:
a component configured to merge two or more trading plans comprising multiple sequences of dates or times so as to optimize the investment of a given quantity of investment funds.

10. The system of claim 8, further comprising:
a sharing component configured to share trading plans between multiple users, such that multiple researchers may share access to each other's trading plans, and saved date sequences and time sequences.

11. The system of claim 8, further comprising:
a locking component configured to verifiably lock at least one trading plan on behalf of an owning user of the at least one trading plan, so that other users may ascertain a predictive quality of the at least one trading plan from the lock date.

12. The system of claim 8, further comprising:
an append-only locking component configured to verifiably lock at least one trading plan on behalf of an owning user of the at least one trading plan while still allowing the owning user to append new future buy and sell trade actions to the at least one trading plan.

13. The system of claim 8, further comprising:
a component configured to, in response to receiving an update to at least one date or time sequence associated with the merged trading plan, update the merged trading plan.

14. The system of claim 8, further comprising:
a component configured to trade on behalf of a client account, wherein the trading is performed in accordance with the constructed trading plan, wherein the trading plan is a fully-determined trading plan.

15. A computer-readable medium storing instructions that, if executed by a computing system having a memory and a processor, cause the computing system to perform a method for generating a trading plan, the method comprising:
receiving, from a user, a plurality of date sequences, each date sequence comprising two or more dates; and
for at least two date sequences of the received plurality of date sequences,
identifying, from among a set of equities, two or more equities having upticks that are positively correlated with the date sequence,
ranking the identified equities that are positively correlated with the date sequence, and
for at least two of the ranked equities,
generating a trading plan for the equity based at least in part on the date sequence and at least one trade limit.

16. The computer-readable medium of claim 15, wherein generating a first trading plan for a first date sequence of the received plurality of date sequences comprises:
for each identified equity having an uptick that is positively correlated with the first date sequence,
creating, within the first trading plan for the first date sequence, a buy action associated with a date of the first date sequence, and
creating, within the first trading plan for the first date sequence, a sell action associated with a date of the first date sequence.

17. The computer-readable medium of claim 16, wherein the buy action is associated with the earliest date of the first date sequence.

18. The computer-readable medium of claim 16, wherein the buy action is associated with a date other than the earliest date of the first date sequence.

19. The computer-readable medium of claim 16, wherein the sell action is associated with the latest date of the first date sequence.

20. The computer-readable medium of claim 16, wherein the sell action is associated with a date other than the latest date of the first date sequence.

21. The computer-readable medium of claim 16, wherein the first trading plan identifies a group of equities and thoroughly-specified buy and sell trading actions for each equity of the group of equities, with specific time and amount of each trading action based at least in part on correlations of the received plurality of date sequences and upticks of the group of equities.

22. The computer-readable medium of claim 15, the method further comprising:
providing, to a user, an indication of the top-ranked identified equities.
